(19) United States
(12) Patent Application Publication
(10) Pub. No.: US 2025/0111398 A1
(43) Pub. Date: Apr. 3, 2025

(54) A SYSTEM AND METHOD FOR DYNAMIC MATCHING OF A REQUEST TO A MEMBER POPULATION

(71) Applicant: ZZIVOR PTE. LTD., Singapore (SG)

(72) Inventor: Hang Ru GOY, Singapore (SG)

(21) Appl. No.: 18/839,038

(22) PCT Filed: Aug. 4, 2023
(86) PCT No.: PCT/SG2023/050541

§ 371 Date: Aug. 16, 2024

(30) Foreign Application Priority Data
Aug. 15, 2022 (SG) 10202250733Q

(51) Int. Cl. G06Q 30/0204; G06Q 30/0202

(52) U.S. Cl. CPC G06Q 30/0204; G06Q 30/0202

(57) ABSTRACT

The invention provides a method for dynamically matching a request from a requestor with a member population. In an embodiment, the present invention enables an application to receive a request based on at least one population profile identifier, sample size and predetermined time for response from a user, and for enabling the application to generate a member population for sending the request to the member population and to determine if the response satisfies predetermined conditions and to present the results of the said activity to the user.

### TECHNICAL FIELD

The present disclosure generally relates to dynamic matching of requests from a requestor. More particularly, it relates to enabling a requestor to dynamically connect with other users of a network based on dynamic requests and dynamically determining connections to prospective candidates based on predetermined attributes that the requestor has selected.

### BACKGROUND

The following discussion of the background to the invention is intended to facilitate an understanding of the present invention. However, it should be appreciated that the discussion is not an acknowledgment or admission that any of the material referred to was published, known or part of the common general knowledge in any jurisdiction as at the priority date of the application.

The existing conventional methods of gathering responses from users of a group often require a long waiting time and mostly without any guarantee of success. For example, in the post and wait method, users put up an advertisement or survey notification, and wait, hoping for a response. The passive waiting is needed with the longer the wait, the higher the number of responses, but with no guarantee that there will be a response. In another method which involves blasting a piece of call to action communication to several users through various channels such as email or social media groups or work groups, for example, email, text, flyers, users simply wait and be hopeful for a response. Other than the waiting time, success of any results is also dependent on the amount of materials sent out which often takes up network bandwidth, flooding of receivers' mailbox and generating excessive waste.

There appears to be no attempt to address this problem. As such, the present invention attempts to overcome at least in part some of the aforementioned disadvantages and to provide for an improved approach for addressing the foregoing challenge.

### SUMMARY OF THE INVENTION

According to a first aspect of the present disclosure, there is provided a method for dynamically matching a request from a requestor with a member population, the method comprising: receiving, from a server, a request from the requestor wherein the request includes at least one population profile identifier, a sample size and a predetermined time period for response; generating, by the processor, an initial member population including one or more candidates, each of whom is relevant to the at least one population profile identifier; generating, by the processor, a final member population including a subset of the initial member population based on a candidate preference and a candidate profile standing. The method further comprises sending, by the server, a first request to a first subset of the final member population; determining whether a number of respondents to the first request in an elapsed time period is more than or equal to the sample size; sending, by the server, a subsequent request to a subsequent subset of the final member population if the number of respondents to the first request is less than the sample size and if the elapsed time period is less than the predetermined time period for response; determining whether a total number of respondents to the first request and the subsequent request in the elapsed time period is more than or equal to the sample size, sending the subsequent request to the subsequent subset of the final member population if the total number of respondents to the first request and the subsequent request is less than the sample size and if the elapsed time period is less than the predetermined time period for response; and transmitting, by the server, to the requestor a visual representation comprising the response obtained by the total number of respondents when the total number of respondents is equal or more than the sample size and the elapsed time period exceeds the predetermined time period for response.

According to other embodiments, the first subset of the final member population is generated by determining an oversampling number, wherein the oversampling number includes an aggregate of the sample size and a predetermined percentage of the sample size.

According to other embodiments, each of the one or more candidates is selected based on its association with the at least one population profile identifier.

According to other embodiments, the candidate preference includes a time availability for response to the first request.

According to other embodiments, the candidate profile standing is indicative of seniority, stature or standing of each of the one or more candidates within the user population.

According to other embodiments, the elapsed time period is indicative of the time passed since the first request was sent.

According to other embodiments, the visual representation includes one or more of the following: statistics, graphics, charts, and table.

According to other embodiments, the at least one population profile identifier includes one or more of the following: age group, gender, birth date, current geolocation, religion, nationality and country of residence.

According to other embodiments the initial member population includes the one or more candidates located within a selected geolocation.

According to other embodiments, the first request sent to the first subset of the final member population is sent at a predetermined time interval.

According to other embodiments, the method further comprises: generating, for the initial member population, a relevance score reflecting a relevance to the at least one population profile identifier.

According to other embodiments, the relevance score is computed based on the association of each candidate to the at least one population profile identifier.

According to a second aspect of the present disclosure, there is provided a system for dynamic matching of a request with a member population, comprising: at least one processor, and at least one memory including computer program code; the at least one memory and the computer program code configured to, with the at least one processor, cause the system to at least to: receive, from a server, a request from the requestor wherein the request includes at least one population profile identifier, a sample size and a predetermined time period for response; generate, by the processor, an initial member population including one or more candidates, each of whom is relevant to the at least one population profile identifier; generate, by the processor, a final member population including a subset of the initial user population based on a candidate preference and a candidate profile standing. It further comprises: sending, by the server, a first request to a first subset of the final member population; determining whether a number of respondents to the first request in an elapsed time period is more than or equal to the sample size; sending, by the server, a subsequent request to a subsequent subset of the final member population if the number of respondents to the first request is less than the sample size and if the elapsed time period is less than the predetermined time period for response; determining whether a total number of respondents to the first request and the subsequent request in the elapsed time period is more than or equal to the sample size, sending the subsequent request to the subsequent subset of the final member population if the total number of respondents to the first request and the subsequent request is less than the sample size and if the elapsed time period is less than the predetermined time period for response; and transmitting, by the server, to the requestor a visual representation comprising the response obtained by the total number of respondents when the total number of respondents is equal or more than the sample size and the elapsed time period exceeds the predetermined time period for response.

According to other embodiments, the first subset of the final member population is generated by determining an oversampling number, wherein the oversampling number includes an aggregate of the sample size and a predetermined percentage of the sample size.

According to other embodiments, each of the one or more candidates is selected based on its association with the at least one population profile identifier.

According to other embodiments, the candidate preference includes a time availability for response to the first request.

According to other embodiments, the candidate profile standing is indicative of seniority, stature or standing of each of the one or more candidates within the user population.

According to other embodiments, the elapsed time period is indicative of the time passed since the first request was sent.

According to other embodiments, the visual representation includes one or more of the following: statistics, graphics, charts, and table.

According to other embodiments, the at least one population profile identifier includes one or more of the following: age group, gender, birth date, current geolocation, religion, nationality and country of residence.

According to other embodiments, the initial member population includes the one or more candidates located within a selected geolocation.

According to other embodiments, the first request sent to the first subset of the final member population is sent at a predetermined time interval.

According to other embodiments, the system further comprises: generating, for the initial member population, a relevance score reflecting a relevance to the at least one population profile identifier.

According to other embodiments, the relevance score is computed based on the association of each candidate to the at least one population profile identifier.

### BRIEF DESCRIPTION OF THE DRAWINGS

In the drawings, like reference characters generally refer to the same parts throughout the different views. The drawings are not necessarily to scale, emphasis instead generally being placed upon illustrating the principles of the invention. The dimensions of the various features or elements may be arbitrarily expanded or reduced for clarity. In the following description, various embodiments of the invention are described with reference to the following drawings, in which:

FIG. 1 is a system diagram of an embodiment of the environment in which the present invention may be practiced in accordance with embodiments of the present invention;

FIG. 2 is an embodiment of a client device that is employed in the method or system implementing the invention in accordance with embodiments of the present invention;

FIG. 3 illustrates a flow chart of an embodiment of the present invention in accordance with embodiments of the present invention;

FIG. 4 illustrates a flow chart of yet another embodiment of the present invention in accordance with embodiments of the present invention;

FIG. 5 illustrates a flow chart of yet another embodiment of the present invention in accordance with embodiments of the present invention;

FIG. 6 illustrates an embodiment of one application of the present invention in accordance with embodiments of the present invention; and

FIG. 7 illustrates an embodiment of another application of the present invention in accordance with embodiments of the present invention.

### DETAILED DESCRIPTION

Reference will now be made in detail to an exemplary embodiment of the present invention, examples of which are illustrated in the accompanying drawings. While the invention will be described in conjunction with the embodiment, it will be understood that they are not intended to limit the invention to these embodiments. On the contrary, the invention is intended to cover alternatives, modifications, and equivalents, which may be included within the spirit and scope of the invention as defined by the appended description. Furthermore, in the following detailed description of embodiments of the present invention, numerous specific details are set forth in order to provide a thorough understanding of the present invention. However, it will be recognized by one of ordinary skill in the art that the present invention may be practiced without these specific details. In other instances, well-known methods, procedures, components, and circuits have not been described in detail as not to unnecessarily obscure aspects of the embodiments of the present invention.

In the specification the term “comprising” shall be understood to have a broad meaning similar to the term “including” and will be understood to imply the inclusion of a stated integer or step or group of integers or steps but not the exclusion of any other integer or step or group of integers or steps. This definition also applies to variations on the term “comprising” such as “comprise” and “comprises”.

Throughout the specification and claims, the following terms take the meanings explicitly associated herein, unless the context clearly dictates otherwise. The phrase “in one embodiment” as used herein does not necessarily refer to the same embodiment, though it may. Furthermore, the phrase “in another embodiment” as used herein does not necessarily refer to a different embodiment, although it may. Thus, as described below, various embodiments of the invention may be readily combined, without departing from the scope or spirit of the invention.

In addition, as used herein, the term “or” is an inclusive “or” operator, and is equivalent to the term “and/or,” unless the context clearly dictates otherwise. The term “based on” is not exclusive and allows for being based on additional factors not described, unless the context clearly dictates otherwise. In addition, throughout the specification, the meaning of “a,” “an,” and “the” include plural references. The meaning of “in” includes “in” and “on.”

Some portions of the description which follows are explicitly or implicitly presented in terms of algorithms and functional or symbolic representations of operations on data within a computer memory. These algorithmic descriptions and functional or symbolic representations are the means used by those skilled in the data processing arts to convey most effectively the substance of their work to others skilled in the art. An algorithm is here, and generally, conceived to be a self-consistent sequence of steps leading to a desired result. The steps are those requiring physical manipulations of physical quantities, such as electrical, magnetic or optical signals capable of being stored, transferred, combined, compared, and otherwise manipulated.

Unless specifically stated otherwise, and as apparent from the following, it will be appreciated that throughout the present specification, discussions utilizing terms such as “monitoring”, “utilizing”, “retrieving”, “providing”, “generating”, “quantifying”, “calculating”, “outputting”, “optimising”, “rebuilding”, “storing”, “mapping”, “checking”, “identifying”, “collecting”, “searching”, “conducting”, “cross-checking”, “aggregating”, “determining”, “regenerating”, “updating”, “comparing”, “adjusting”, “compiling”, “processing”, “triggering”, “performing”, “obtaining” or the like, refer to the action and processes of a computer system, or similar electronic device, that manipulates and transforms data represented as physical quantities within the computer system into other data similarly represented as physical quantities within the computer system or other information storage, transmission or display devices.

As used herein, the term “receiving” requests, responses, communications and any types of multimedia contents from a device or component includes receiving the requests, responses, communications, and any types of multimedia contents indirectly, such as when forwarded by one or more other devices or components. Similarly, “sending” a request, responses, communications, and any types of multimedia contents to a device or component includes sending the request, responses, communications, and any types of multimedia contents indirectly, such as when forwarded by one or more other devices or components.

In addition, the present specification also implicitly discloses a computer program, in that it would be apparent to the person skilled in the art that the individual steps of the method described herein may be put into effect by computer code. The computer program is not intended to be limited to any particular programming language and implementation thereof. It will be appreciated that a variety of programming languages and coding thereof may be used to implement the teachings of the disclosure contained herein. Moreover, the computer program is not intended to be limited to any particular control flow. There are many other variants of the computer program, which can use different control flows without departing from the scope of the specification.

To achieve the stated features, advantages and objects, the present invention is directed to a system and method of dynamically matching requests from a requestor to users of a network. More particularly, it relates to enabling a requestor to dynamically connect with other users of a network based on predetermined or structured request and identifies, determines, suggests connectable prospective candidates based on the predetermined or structured request for users to establish connections and presenting such candidates to the users. This provides a user with the advantage of identifying prospects instead of suspects in traditional methods of shortlisting users or candidates through matching of statistics in a database. Additionally, the system is able to provide user identifications within a predetermined time period for a predetermined number of prospects.

Various embodiments provide for a system and method for dynamic matching of requests from a requestor (or user) to prospective candidates on a network. The object of the invention is to enable the user to dynamically connect with other users of the network based on dynamic requests, and dynamically determining connections to other users of the network based on predetermined attributes that the user has selected.

In another embodiment, the present invention determines potential or prospective candidate connections for the user; generating a list of potential or prospective candidate connections not connected to the user based on predetermined attributes that user has selected; presenting a list of potential or prospective candidate connections not connected to the user, and to enable the user make new connections and/or connect to one or more candidate connections from the list of potential or prospective candidate connections.

In another embodiment, the present invention enables a user to send a request based on inputting and selecting predetermined criteria to multiple users, and for enabling a server to receive said request and to determine and present prospective and suggested candidates to the user to dynamically establish connections or communications with one or more selected candidates for conducting one or more activities, actions, events, communications, collaborations, polls surveys and to present the results of the said activity to the user.

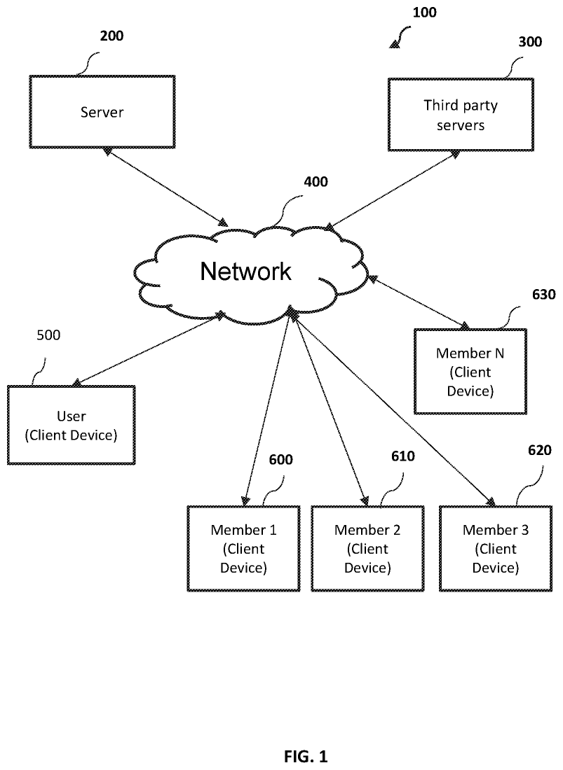

FIG. 1 shows a block diagram illustrating a system for dynamic matching of a request from a user to prospective candidates. FIG. 1 shows components of one embodiment of an environment in which the invention may be practiced. Not all the components may be required to practice the invention, and variations in the arrangement and type of the components may be made without departing from the spirit or scope of the invention. As shown, system 100 of FIG. 1 includes a client device 500. The system also includes a network or a wireless network 400, a server 200, third party servers 300, and client devices 600, 610, 620, 630 belonging to prospective candidates.

A variety of client devices may be employed in accordance with the invention. The client devices (user and candidate) may include mobile devices, smart phones, smart devices, tablets, PCs such as personal computers and media centers, and other client devices. Generally, a mobile device may include virtually any portable computing device capable of receiving and sending a message over a network, such as a network 400, or the like. A mobile device may also be described generally as a client device 500 that is configured to be portable. The mobile device may have the capability of connecting to a network using wireless technology, wired technology, or a combination of both wired and wireless technologies. Thus, the mobile device may include virtually any portable computing device capable of connecting to another computing device and receiving information. Such devices include portable devices such as cellular telephones, smart phones, display pagers, radio frequency (RF) devices, infrared (IR) devices, Personal Digital Assistants (PDAs), handheld computers, sensors, laptop computers, wearable computers, tablet computers, integrated devices combining one or more of the preceding devices, and the like. As such, the mobile device typically ranges widely in terms of capabilities and features. In one example, a cell phone or web-enabled mobile device may have a touch sensitive screen, a stylus, and several lines of color LCD display in which both text and graphics may be displayed.

The client device 500 may include one or more other client applications that are configured to receive content from another computing device. The client application may include a capability to provide and receive textual content, graphical content, audio content, video content, and the like. The client application may further provide information that identifies itself, including a type, capability, name, and the like. In one embodiment, the client device 500 may uniquely identify itself through any of a variety of mechanisms, including a phone number, Mobile Identification Number (MIN), an electronic serial number (ESN), or other mobile device identifier. The information may also indicate a content format that the mobile device is enabled to employ. Such information may be provided in a message, or the like, sent to the server 200 or other computing devices.

Use of the term ‘server’ herein can mean a single computing device or a plurality of interconnected computing devices which operate together to perform a particular function. That is, the server may be contained within a single hardware unit or be distributed among several or many different hardware units.

The client device 500 communicates with the server 200, and the server communicates with other client devices of prospective candidates and/or one or more third party servers 300. In one embodiment, the user employs a client device 500 to send or receive a request data to other client devices of prospective candidates. The server 200 receives and process the request data from the client device 500. The server 200 searches and matches a set of prospective candidates based on the request data. The server 200 may employ identifiers or addresses of the prospective candidates. For example, it may employ user id or email addresses of a sender and/or receiver. The server 200 may employ any one or more of these identifiers or addressing mechanisms when communicating with a sender and/or receiver. As used herein, the terms ‘sender’ and ‘receiver’ may be used to refer to a person, a device, or a combination of a person and a device.

In one embodiment, a user may register himself/herself and create a user account on the system 100. The system 100 is in communication with a database. The database stores user profile data relating to registered users and includes username, user address, user account identifier, password, given name, identity card number, account numbers, contact number, facial images, biometric data, application settings. In other embodiments, the user data may include content or database of web sites and server of web site, data of social network, data, resources digital content and index data of search engines, user generated data, shared data, user inputted, selected and disclosed data, user activities, events, actions, behaviour, current location and place, transactions and interaction. As used herein, user profile data refers interchangeably with user profile identifiers and refers to any data that identifies a user, consumer, provider, employee. In another embodiment, the user is a system administrator, a business entity, or an institution, in communication with the server or third party servers.

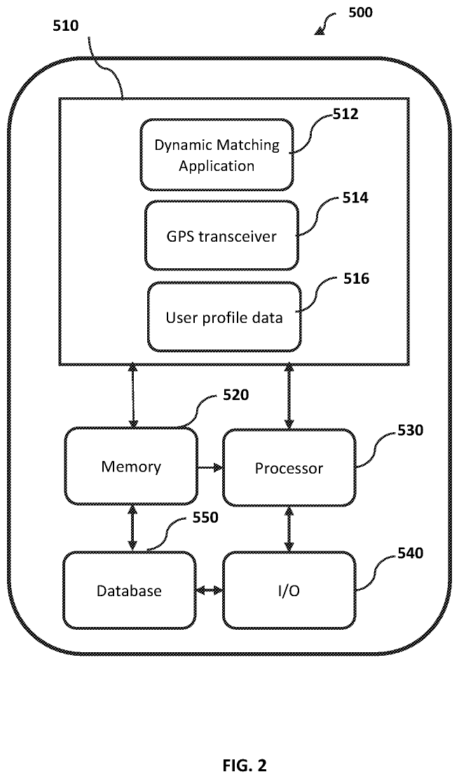

FIG. 2 shows a diagram of an exemplary client device 500 illustrating a computing system configuration that may be associated with a user or a candidate consistent with the disclosed embodiments. In some embodiments, the client device 500 may include a database 550, one or more processors 530, one or more memories 520, and one or more input/output (I/O) devices 540. In some embodiments, the client device 500 may take the form of a server, general purpose computer, a mainframe computer, a laptop, smartphone, mobile device, or any combination of these components. In certain embodiments, the client device 500 may be configured as a particular apparatus, system and the like based on the storage, execution, and/or implementation of the software instructions that enable performance of one or more operations consistent with the disclosed embodiments. The client device 500 may be standalone, or it may be a part of a subsystem, which may be part of a larger system.

The client device 500 includes a dynamic matching application that includes a user interface for searching, matching, navigating, browsing, selecting, sorting, accessing, connecting to other candidate devices. The dynamic matching application provides an interface to enable communication with each of the candidate devices, the server and/or third party servers. The application may include computer executable instructions, which, when executed by the client device 500, transmit, receive, and/or otherwise process request data, messages, content, and enable communication with another user of another client device.

The client device 500 includes a GPS transceiver 514 to determine the physical coordinates of the client device. The GPS transceiver 514 may employ other geo-positioning mechanisms or systems, including but not limited to, triangulation, to further determine the physical location of the client device. In other embodiments, the client device, may, through other components, provide other information that may be employed to determine a physical location of the client device, for example, a MAC address, IP address, or the like.

The system 100 provides an application programming interface (“API”) to facilitate such communication. Such APIs may be part of a user interface that may include graphical user interfaces (GUIs), Web-based interfaces, programmatic interfaces such as application programming interfaces (APIs) and/or sets of remote procedure calls (RPCs) corresponding to interface elements, messaging interfaces in which the interface elements correspond to messages of a communication protocol, and/or suitable combinations thereof. Examples of APIs include the REST API, and the like. In various embodiments, the system 100 can be implemented as a technology layer. In various embodiments, the system 100 can be deployed as a standalone application where a company uses it exclusively as a dynamic matching application. In some embodiments, social network providers can integrate the system 100 into the social network interface and database.

The processor 530 may include a microprocessor, an analogue circuit, a digital circuit, a mixed-signal circuit, a logic circuit, an integrated circuit, a Central Processing Unit (CPU), a Graphics Processing Unit (GPU), a Digital Signal Processor (DSP), a Field Programmable Gate Array (FPGA), an Application Specific Integrated Circuit (ASIC), etc., or any combination thereof. Any other kind of implementation of the respective functions, which will be described below in further detail, may also be understood as the processor 530.

In some embodiments, the client device 500 may further include a memory 520. The memory may be used by the processor 530 to permanently or temporarily store, for example, request data to be processed by the dynamic matching application for sending to the server 200 for matching with prospective candidates. The memory 520 may include one or more storage devices configured to store instructions used by processor to perform functions related to the disclosed embodiments. The memory may include, but not be limited to, a cloud memory, a server memory, and a physical storage, for example a RAM (random-access memory), an HDD (hard disk drive), an SSD (solid-state drive), others, or any combinations thereof.

Memory may further include user data. User data may include information about particular users of the system. For example, user data may include user data may include content or database of web sites and server of web site, data of social network, data, resources digital content and index data of search engines, user generated data, shared data, user inputted, selected and disclosed data, user activities, events, actions, behaviour, current location and place, transactions and interaction.

I/O devices 540 may be one or more devices that are configured to allow data to be received and/or transmitted by the client device 500. I/O devices may include one or more digital and/or analog communication devices that allow the client device 200 to communicate with other machines and devices, such as other components of system 100 shown in FIG. 1. For example, the client device 500 may include interface components, which may provide interfaces to one or more input devices, such as one or more keyboards, mouse devices, and the like, which may enable the client device 500 to receive input from an operator of the device.

The client device may also contain one or more databases 550. Alternatively, the client device 500 may be communicatively connected to database 550 through a network. Database 550 may include one or more memory devices that store information and are accessed and/or managed through the client device 500. Database may include computing components (eg. database management system, database server, etc.) configured to receive and process requests for data stored in memory devices of databases and to provide data from database.

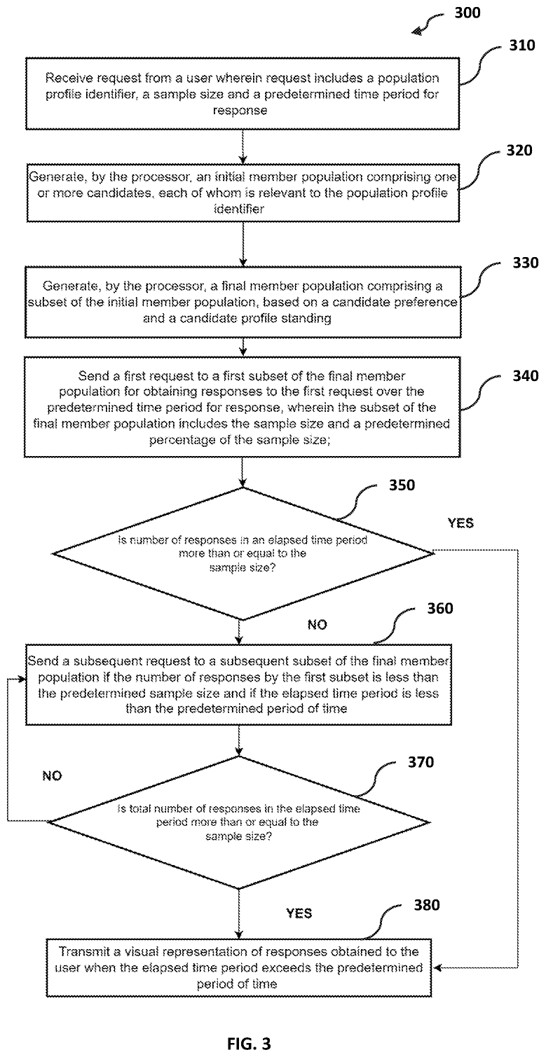

FIG. 3 provides a flow chart showing an embodiment of a method for dynamic matching of a request from a user to a member population of a dynamic matching application. The method may be performed by a server 200 of the system 100 executing instructions encoded on a computer-readable medium storage device. It is to be understood that one or more steps of the process may be implemented by other components of the system 100 including the client devices 200, 600. In some embodiments, the member is a subscriber or a member of the dynamic matching application, which can be paid or unpaid, or a combination of paid and unpaid services. Such services can be purchased on a one time basis, monthly basis or an annual basis. The application may also provide paid services for users to purchase a single request or a predetermined number of requests based on usage needs. In some embodiments, the user is an individual, a system administrator, a business entity, or an institution, that is in control of the client device 500 in communication with the server or third party servers. In some embodiments, the application allows users to sign up and to use the application for free for a limited period of time or to have the use limited to certain services, or both.

The request or query may include a string of words that the user may input into an input device, for example, a mobile device. For example, the request or query may include the string of words that the user may type into a search field or a query field of an application program. The request or query may be referred to as a search query. In some embodiments, the application program can be installed on an input device and includes one or more of the following applications:
(i) an academic or market research tool used in the areas of social sciences, politics, economics, and the like;
(ii) an instant opinion gathering tool for institutions and companies where a quick informal poll, feedback or survey can be conducted;
(iii) a personal companion tool for validating personal and external opinions and for clarifying doubts and for a user to make more informed decisions;
(iv) a real time opinion tool where users can supplement subject matter expertise from other users or for informing or moderating discourse;
(v) social and cultural experiments where random social experiments can be conducted;
(vi) brand or social barometer tool for gauging product or service under the brand or socio-political sentiments and trends;
(vii) an expertise or consultancy tool for obtaining experts' opinions;
(viii) a survey tool for conducting quick personal survey in a short turnaround time;
(ix) a partner matching tool for seeking connections with other users with similar professions, skillsets or interests;
(x) targeted distribution of digital flyers;
(xi) SOS tool for matching emergency medical, life-threatening cases or potential suicide cases with suitable medical, psychiatric or psychological expertise or donors.

At step 310, the server 200 receives the request from the user for dynamic matching of the request to the member population. The request may include the user's one or more activities, actions, events, transactions, requests, search queries, preferences, match making preferences, interactions, behavior, senses, location, places, current location or place. In some embodiments, the request is configured by the user based on predetermined questions requesting the user to input the user's replies that will collate the request data. In another embodiment, the request is configured by the user based on one or more of the following indicators or criteria: Population profile identifier; Sample size, N; Cut-off time for response to a request or predetermined period of time for response to a request; and a response metric. The response metric refers to the type or criteria of response by the respondents. The response metric can be configured by the user or by the application. For example, the response metric can be a single instance response, an auto recurring response, or within a predetermined geolocation. In another embodiment, the request includes user input and or user selections via one or more types of controls including a list, check box, pre-defined or user created or system created criteria, conditions, rules, words, phrases, sentence, commands, match making preferences, database fields, attributes, user profile, user connections, or user data.

In some embodiments, the population profile identifier includes gender, birth dates, race, nationality, religion, education, profession, skillsets, interest groups, place or country of residence, or other socio-economic data or demographic data in which information is gathered about a group to better understand a group of members' composition or behaviors. It also includes any other identifying information about an individual user profiles that indicate a similarity, association and/or relevance of a user with a group of members. In some examples, the population profile identifier corresponds to members that have some association with a location identifier. Example location identifiers can include a location (eg. Country of residence, location of interest), location of an interest group, an event, a locale (e.g., a town, a city, a neighborhood) and the like. The data provided in the request can be processed to identify a group of users that are common, associated or relevant with the population profile identifiers. In some implementations, the request can be a relatively simple query to provide a broad range of results. Using a location (e.g., a café, a restaurant, a theater) as an example subject, an example request can be directed to users that have visited the location.

In some embodiments, the processor may include a request understanding module. The request understanding module may include one or more machine learning models. In some embodiments, the request understanding module may be or include a collection of machine learning models such as an entity recognition, a query correction, a query rewrite, and an intent recognition. The machine learning models may work together to process the request that the user submits and provide insights that may be used by the processor to generate the group of members that may match the targeted user profile identifiers and subject identifiers by the user.

The request understanding module may receive the input data relating to the request and predict a search intent from the request. For example, if the request includes “travel”, the request understanding module may predict whether the request of “travel” is intended to be a vacation travel or a journey to a destination. This prediction may be performed based on a machine learning technology. In some embodiments, the search intent may correspond to each field which may be based on the application program. For example, in the partner matching program, predefined search intents may include a vacation travel or a journey to destination.

At step 320, the server 200 searches its database that includes members of an application or a network and generates an initial member population comprising one or more prospective candidates or users among members of the database, users of the application or network that are similar, relevant or associated to the one or more population profile identifiers. In another embodiment, the server 200 sends the request to a third party server 300, for example, a client server. The third party server 300 includes a third party database or a membership database and searches the third party database that includes the user data of prospective candidates and generates the initial member population including one or more prospective candidates among users or members of the application or network based on the request. The initial member population is generated based on each of the candidates' similarity, association or relevancy to the one or more population profile identifiers as mentioned above.

At step 330, the server generates a final member population comprising a subset of the initial member population based on a candidate preference and a candidate profile standing. In some embodiments, the candidate preference refers to each candidate's preferences, for example, this may include the candidates' time availability for a response. For example, a candidate may state that he prefers to be requested for a response once a week, another candidate may state that she does not want to be contacted at all. A candidate profile standing is an indicator of a candidate's seniority, stature or standing in a membership community or group or a profession. In another embodiment, the candidate profile standing can be determined by the server through artificial intelligence and assigned to the members based on their responsiveness, their seniority, status, activity, credibility, membership profile etc..

In some embodiments, the server generates, for each member, a relevance score reflecting a relevance to the one or more population profile identifiers in the request. The processor may generate the relevance scores by parsing the request into one or more population profile identifiers. For example, if the request relates to “I want to look for 2 female travelling companions who are 20 to 30 years old, graduated from college, living in Singapore to travel together to China in July 2022” into the search field of the application program, the server. Examples of population profile identifiers include “female”, “20-30 years old”, “college graduate”, “Singapore residence”. Other population profile identifier examples include “travellers”, “China”, “July 2022”. The relevance scores for each member are generated based on commonality of the population profile identifiers with the members in the database. In some implementations, the relevance score can be based on the frequency at which a particular member interacts with the population profile identifier. For example, in the case of a “travel companion”, the relevance score can be based on the frequency at which a member travels outside the country of residence. The more frequently the member travels outside the country of residence, the higher the relevance score. In some implementations, whether a respondent member is presented to the member who submitted a request can be determined based on a threshold relevance score. For example, the relevance score generated for each member can be compared to the threshold relevance score. If the relevance score is greater than or equal to the threshold relevance score, the identified respondent member is deemed to be sufficiently relevant to the user and is presented to the user. If the relevance score is not greater than or equal to the threshold relevance score, the particular member is not deemed to be sufficiently relevant to the user and will not be selected for the next step.

At step 340, the server 200 sends a first request to a first subset of the final member population for obtaining responses to the first request over the predetermined time period for response. As mentioned above, the predetermined time period for response is configured by the user or by the application as a default time period for response. From among the final member population, the first subset of the final member population includes a lesser number of prospective candidates of the final member population. The first subset of the final member population is generated by oversampling based on the sample size configured by the user or the sample size limit predetermined by the application. Based on the sample size configured by the user or sample size limit, the first subset will further add an additional sample size defined by a predetermined percentage of the sample size or the sample size limit. The advantage of doing so provides the user with an increased chance of obtaining responses from the final member population in the event of low response rate. In other words, the application determines the first subset of the final member population by determining an oversampling number based on the following:

$${N}_{R} > ( N - n ( t ) ) + X \%$$

where R is the sampling iteration number (1,2,3 . . . ) & X is the additional sample size in percentage terms defined by the application.
Once the first subset of the final member population is determined by obtaining the oversampling number, the request is sent to the first subset and the candidates within the final member population are selected on a random basis.

At step 350, the server 200 determines if the number of responses by the first subset of the final member population in an elapsed time period is more than or equal to the sample size. The elapsed time period (t) is the time that has passed since the first request was sent to the first subset of the final member population. If the number of respondents from the first subset of the final member population in the elapsed time period (t) is more than or equal to the sample size (N), step 370 will be triggered to transmit to the user a visual representation of results of responses obtained from the respondents. If the number of respondents (n) from the first subset of the final member population is less than the sample size (N), at step 360, the server sends the same request to the non-respondents in the first subset of the final member population provided the elapsed time period (t) is less than the predetermined time period for response or cut-off time (T). In other words, the subsequent or second request will not be sent to the respondents to the first request.

The predetermined time period for response (T) is configured by the user who submitted the request or the application program imposes a default predetermined time period for response to the request. For example, the predetermined time period (T) for respondents to respond to the request can range from as short as a minute to as long as a couple of days. This is done so as to increase the chances of obtaining the sample size (N) over the predetermined time period or within the cut-off time (T). The server monitors and determine the number of respondents over the elapsed time period (t) and the process repeats until the sample size (N) is met or the elapsed time period (t) meets or exceeds the predetermined time period (T). In order to achieve a certain level of precision in the request results, the remaining number of users from the group of users are determined based on the following formula:

Nₙ(t)

where:
(i) N is the respondent size predetermined by the user or system;
(ii) Nₙ (t)>N−n(t);
(iii) n(t) is the response gathered so far at time t; and
(iv) t<T, where t is the time elapsed, and T is the predetermined period of time.

In the event the elapsed time period (t) has exceeded the predetermined time period (T), the server will proceed to step 380 and transmit to the user the visual representation of results of responses obtained from the respondents of the request.

At step 370, the server 200 determines if the total number of responses by the first subset and the subsequent or second subset of the final member population within the elapsed time period is more than or equal to the sample size. If the total number of responses by the first subset and the second or subsequent subset is not equal or does not exceed the sample size, the server 200 will continue to send a subsequent request as long as the elapsed time period does not meet or exceed the predetermined time period for response. The termination condition is reached when the total number of responses from the first and/or subsequent subsets is equal to or exceeds the sample size, or when the elapsed time period meets the predetermined time period for response.

At step 380, once the elapsed time period is equal to or exceeds the predetermined time period (T), the server transmits to the user the visual representation of results of responses obtained from the respondents of the request. The visual representation can be in the form of statistics, table, graphics, charts or the like such that the results are visually digestible and readable by the user. In some implementations, user identifier data of the respondents may be provided to the user. In some implementations, the server will also transmit to the user one or more user identifier data of the respondent members who responded to the request. In some implementations, the user identifier data may be an email address. In some implementations, the user identifier data may be automatically anonymized such that the user does not know who the respondent member is until the respondent member provides consent for the user identifier data to be revealed. In some implementations, the server transmits an aggregated response to the request that includes a summary of the responses provided by the respondent users.

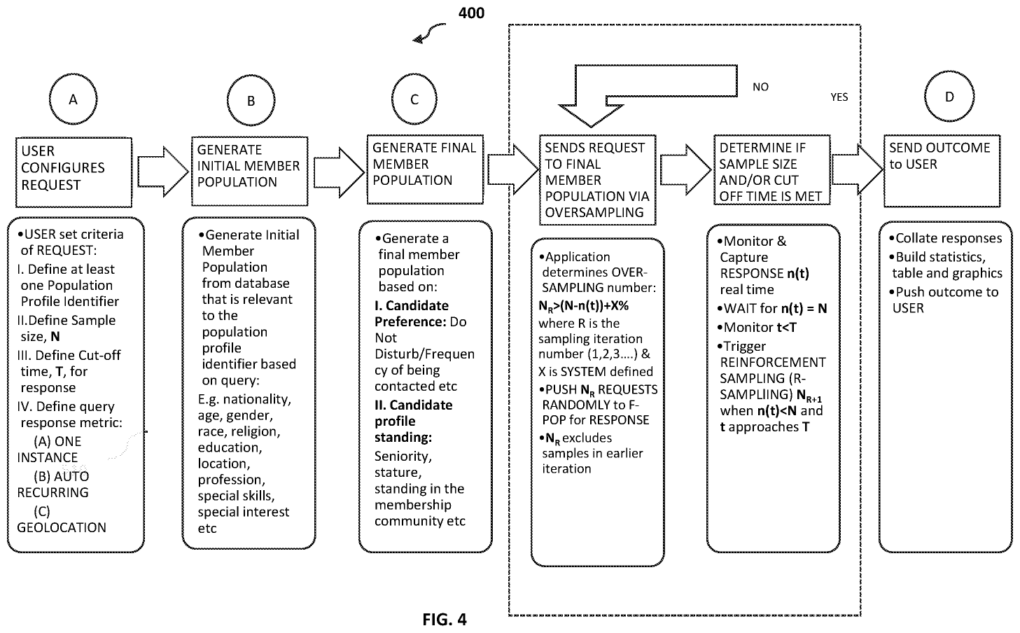

FIG. 4 provides a flow chart 400 showing yet another embodiment of a method for dynamic matching of a request to a member population. The flow chart is similar to the previous figure and is presented to provide the steps in a visual manner. The steps provided in FIG. 4 correspond to some of the steps provided in FIG. 3 and details of the steps can be obtained from the above detailed description of FIG. 3.

Step A corresponds to step 310 of FIG. 3. At Step A, the application receives the request from the user for dynamic matching of the request to a member population. The request may include at least one population profile identifier, a sample size of the user population (N) for sending a request to, and a cut-off time (T).

Step B corresponds to step 320 of FIG. 3. At step B, based on the criteria provided by the user or the defaults placed by the application (for example, maximum sample size or maximum cut-off time), the application searches its member database that includes both paid and unpaid members of an application and generates an initial member population comprising one or more candidates among the members of the database. The candidates are generated based on its similarity, relevancy or association to the one or more population profile identifiers predetermined by the user.

Step C corresponds to step 330 of FIG. 3. At step C, the application generates a final member population comprising a subset of the initial member population based on a candidate preference and a candidate profile standing. In some embodiments, the candidate preference refers to each candidate's preferences, for example, the candidate's time availability for a response. For example, a candidate may state that he prefers to be requested for a response only once a week, another candidate may state that she does not want to be contacted at all. A candidate profile standing is an indicator of a candidate's seniority, stature or standing in a membership community or group or a profession. In another embodiment, the candidate profile standing attribute can be determined by the server through artificial intelligence and assigned to the members based on their responsiveness, their seniority, status, activity, credibility, membership profile etc..

The application then proceeds to a dynamic request stage and a dynamic response stage. The dynamic request stage corresponds to Steps 340 and 360 of FIG. 3, while the dynamic response stage corresponds to Steps 350 and 370 of FIG. 3. Each dynamic request stage is followed by a dynamic response stage until a termination condition is reached. In the dynamic request stage, the application sends a first request to a subset of the final member population. In some embodiments, this subset is determined by the application determining an oversampling number, as encapsulated in the formula mentioned above. The first request is sent out to the subset of the final user population in a random manner. The application then monitors the number of responses obtained in the dynamic response stage. The dynamic response is conditioned by the number of responses obtained from the respondents and the elapsed time period since the first request was sent. Depending on which condition is satisfied, a dynamic response is activated. The application will either proceed to terminate the process or to continue with the dynamic request stage once again. If the number of responses obtained from the respondents is equal to or exceeds the sample size, the application will proceed to terminate the process and send to the user a visual representation of the responses. If not, the application will continue to send a subsequent request to the non-respondents within the subset of final user population until a termination condition is reached. Once the termination condition is reached, the application will proceed to send to the user a visual representation of the responses obtained from the respondents. The termination condition is reached when an elapsed time period (from the time the first request is sent to the user population) is equal to or exceeds the cut-off time for response or when the number of respondents is equal to exceeds the sample size.

Step D corresponds to step 380 of FIG. 3. At step D, once the termination condition is reached, the application transmits to the user the visual representation of results of responses obtained from the respondents of the request. The visual representation can be in the form of statistics, table, graphics, charts or the like such that the results are visually digestible and readable by the user. In some implementations, user identifier data of the respondents may be provided to the user. In some implementations, the server will also transmit to the user one or more user identifier data of the respondent users who responded to the request. In some implementations, the user identifier data may be an email address. In some implementations, the user identifier data may be automatically anonymized such that the user does not know who the respondent member is until the respondent member provides consent for the user identifier data to be revealed. In some implementations, the server transmits an aggregated response to the request that includes a summary of the responses provided by the respondent members.

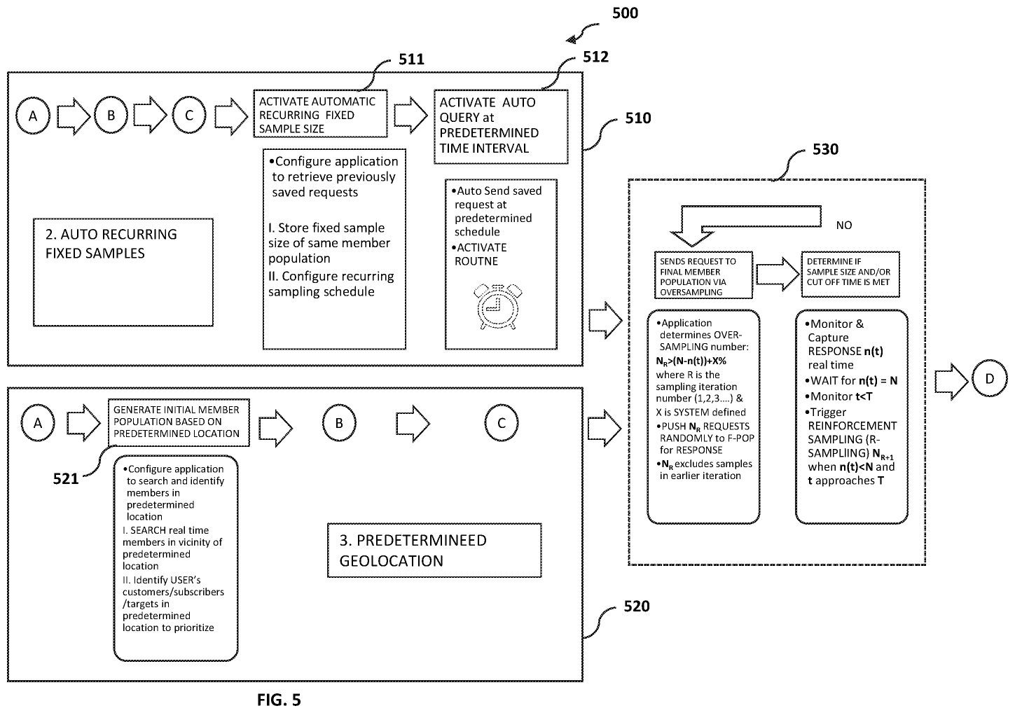

FIG. 5 provides a flow chart 500 showing yet another embodiment of a method for dynamic matching of a request to a member population. The flow chart is similar to the previous figures (FIGS. 3 and 4) and is presented to provide the steps in a visual manner. Steps A-D of FIG. 5 correspond to steps A-D of FIG. 4 and some of the steps in FIG. 3 and details of the steps can be obtained from the above detailed description of FIGS. 3 and 4.

Block 510 illustrates another embodiment of the method for dynamic matching of a request to a member population. At the end of Step C, step 511 is activated. Step 511 refers to sending out requests based on an automatically recurring fixed sample size number. In this step, a request is sent to the selected subset of the final member population. In some embodiments, the request is based on a previously configured request or historical request by the user that is saved and stored on the user account or on the server. The user simply retrieves the previously configured request or historical request and configures the new request based on the same fixed sample size number as the historical request or a new fixed sample size number. In some embodiments, the fixed sample size can be the same selected subset of the final member population, i.e. the same members that were used for the previous request or it can be different set of selected subset of the final member population. In some embodiments, the selected subset of the final member population is determined by the user or by the application and is determined by the sample size configured by the user or by the application. In some embodiments, the user can also configure the application to send out the request at predetermined time intervals at step 512. For example, if a user had previously sent out a request relating to a poll relating to a product, service, event or incidence, he can configure the poll to be sent out at a predetermined time interval, eg. on a weekly, monthly or annual basis to the selected subset of the final member population. In this step, the application sends out requests to the selected subset of the final member population at predetermined time intervals, for example, once a month. The application similarly monitors the responses obtained by the subset of the final member population and sends out subsequent requests only to the non-respondents within the subset of the final member population. In some embodiments, the application monitors the responses obtained by the subset of the final member population, and sends out subsequent requests only to the non-respondents within the subset of the final member population. In this way, the application provides the user the convenience of tracking any changes or trends in the member population's opinions, attitudes, sentiments on a service, product, event, incidence, etc..

Block 520 illustrates another embodiment of the method for dynamic matching of a request to a member population. At the end of Step A, step 521 is activated. Step 521 generates an initial member population based on a selected population profile identifier. For example, a location. Location can include current real-time location of members, current residence of members, country of residence, etc.. This provides another way for a user to prioritize and focus on certain criteria of the request. If the user wishes to focus on a predetermined geolocation because of the demands of the request, for example, the request may relate to a real-time survey at a particular conference and the survey only wishes to poll the attendees of the conference, the initial member population can be generated based on the real-time location of the attendees of the conference. In some examples, the user may wish to poll participants, members or crowd at a concert, political rally, or within a certain geolocation where large groups of members are present, for example, at a land crossing between two countries, or other events. In other examples, the user may be a corporate entity or a retail business that has plans for a special promotion activity for a limited time duration. For example, the retail business may offer a claim to free ice-cream if you drop by the booth/shop between 6-8 pm, or a restaurant may offer a 1-for-1 lunch hour special today for the first 10 customers only, or a hawker stall may offer a one dollar chicken rice between 5-6 pm today, or a gym may offer a 20% discount if you sign up for a gym membership today. In some embodiments, step 521 generates an initial member population based on a selected geolocation. The application or server searches and identifies its member database for members who are currently within the selected geolocation, and generates the initial member population based on the members who are within the selected geolocation.

Block 530 refers to the dynamic request and dynamic response stages as described above in FIGS. 3 and 4. In some embodiments, the user can configure the request to proceed to the dynamic request and dynamic response stages if the user has opted to activate steps 511-512 or steps 521. It is envisaged by a person skilled in the art that step 521 can be activated first followed by steps 511 and 512 if the user chooses to do so.

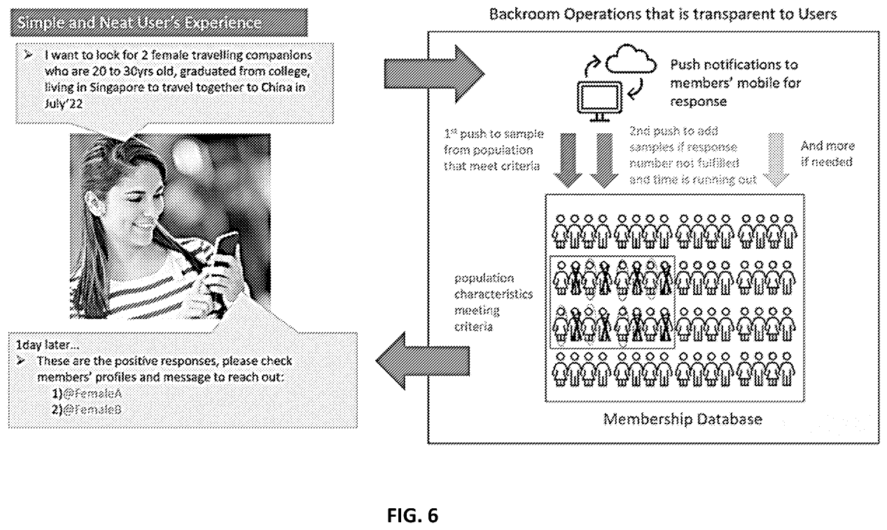

FIG. 6 illustrates an embodiment of another application of the present invention in accordance with embodiments of the present invention. In use, the system provides a user interface, for example on an application program, for enabling a user to facilitate connections with a group of members within a predetermined period of time based on a request inputted by the user. For example, the system 100 allow a user to request for data relating to a specific search request in the context of a travel companion application. In another embodiment, the system 100 requests a call to action from candidates to respond to an advertisement or a marketing proposal. The user inputs the request based on specific user profile identifiers or preferences or attributes of a travel companion that the user would like to travel with. In the case of an advertisement, the request is based on user profile identifiers for example, specific preferences, attributes or profiles of candidates that the business entity would like to reach out to. The user profile identifiers can be gender, age range, educational qualifications, resident status, nationality, travel location, preferred date of travel. The user inputs and update the request via auto fill ups, input, edit remove, predetermined criteria. The user can also manually input data about the user, such as social network information, activities, actions as part of the request data.

The server 200 will process the request by searching and generating a group of prospective candidates among members of an internal or external database based on the request received. The database containing the member data can belong to the server 200 or to a third party server 300, depending on the application access settings, or whether the user data is within the server 200 or it belongs to a third party server 300. Within a predetermined period of time, the system monitors and tracks the number of responses received by the first group of matched prospective candidates. The predetermined time period is configurable and determined by the user or the system. The system 100 will determine if the number of responses received by the server within the predetermined time period meet or exceed a threshold target number of responses. If the number of responses does not meet or exceed a threshold target number of responses, the server will proceed to send a subsequent request to a second group of prospective candidates in the database, which are different from the first group of prospective candidates, that matches at least one or more criteria of the request data. For example, the second group of prospective candidates may have one or more user attributes or preference that are similar or identical to the attributes or preferences that the user had indicated in the request data. The system will then track and monitor the number of responses received by the server within a second predetermined time period, which may be identical, less or more than the predetermined time period for the first request. If the total number of responses from the first group and/or second group of prospective candidates is not equal to or exceed the target number of responses, the system 100 will continue to send a subsequent request to a further group of prospective candidates, which can be the same or different group of prospective candidates from the first group and the second group of candidates. The system 100 will proceed to send the subsequent request once a predetermined time period has expired until a termination condition is reached, following which the subsequent request is terminated. In other words, the system will continue to send subsequent requests repeatedly until the termination condition is reached. The termination condition is reached when the number of responses from the first and subsequent group(s) of candidates are equal or exceeds a threshold number, or when the number of responses from the subsequent groups of candidates are equal or exceeds a threshold number. Once the system determines that the total number of responses from the first request and the second request meet or exceeds the target number of responses, the system will present the matched prospective candidates to the user.

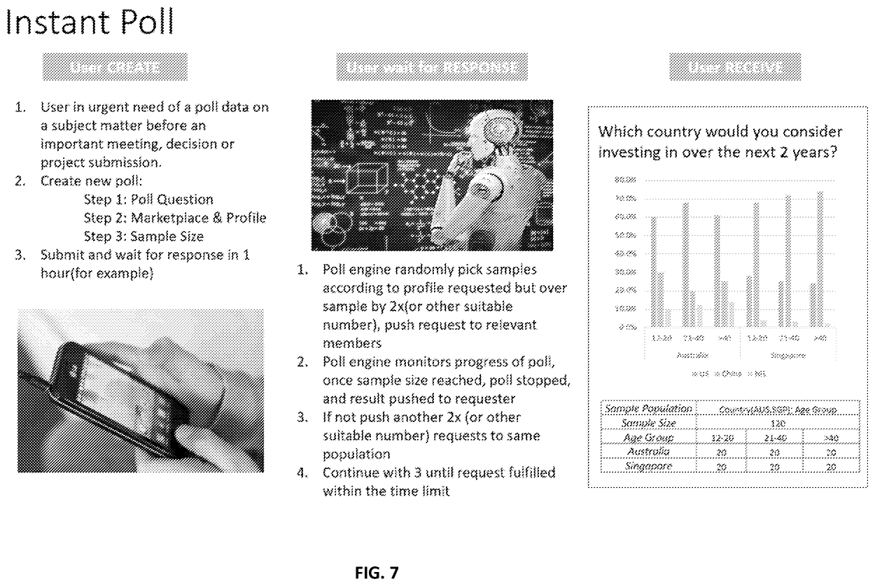

FIG. 7 illustrates an embodiment of a second application of the present invention in accordance with embodiments of the present invention. In use, the system provides a user interface for enabling a user to conduct an online survey within a predetermined period of time. For example, a user may be in urgent need of conducting a poll on a specific subject matter before an important meeting, decision or project submission. The system allows the user to create a request data by creating a survey form that allows the user input specific questions with possible answers and sending this request data for connecting with prospective or matched candidates within a predetermined time period based on request data inputted by the user, and presenting the results of the survey to the user. The user interface includes contextual, domain, field subject, communication utilities, content such as survey forms or presentation that enable the receiving parties to fill the form. The user inputs and update the request data via auto fill ups, input, edit remove, predetermined criteria.

The system 100 will process the request data by searching and matching a group of prospective candidates among members of the database based on the request data received. The database containing the member data can belong to the server 200 or a third party server 300, depending on the application access settings. Within a predetermined time period, the system monitors and tracks the number of responses received by the first group of matched prospective candidates. The predetermined time period is configurable and determined by the user or the system. The system 100 will determine if the number of responses received by the server within the predetermined time period meet or exceed a threshold target number of responses. If the number of responses does not meet or exceed a threshold target number of responses, the server will proceed to send a subsequent or a second request to a subsequent or second group of prospective candidates in the database, which are different from the first group of prospective candidates, that matches at least one or more criteria of the request data. For example, the second group of prospective candidates may have one or more user attributes or preference that are similar or identical to the attributes or preferences that the user had indicated in the request data. The system will then track and monitor the number of responses received by the server within a second predetermined time period, which may be identical, less or more than the predetermined time period for the first request. If the total number of responses from the first group and/or second group of prospective candidates is not equal to or exceed the target number of responses, the system 100 will continue to send a subsequent request to a subsequent group of prospective candidates, which can be the same or different group of prospective candidates from the first group and the second group of candidates. The system 100 will proceed to send the subsequent request once a predetermined time period has expired until a termination condition is reached, following which the subsequent request is terminated. In other words, the system will continue to send subsequent requests repeatedly until the termination condition is reached. The termination condition is reached when the number of responses from the first and subsequent group(s) of candidates are equal or exceeds a threshold number, or when the number of responses from the subsequent groups of candidates are equal or exceeds a threshold number. Once the system determines that the total number of responses from the first request and the second request meet or exceeds the target number of responses, the system will present the survey results to the user.

While the invention has been particularly shown and described with reference to specific embodiments, it should be understood by those skilled in the art that various changes in form and detail may be made therein without departing from the spirit and scope of the invention as defined by the appended claims. The scope of the invention is thus indicated by the appended claims and all changes which come within the meaning and range of equivalency of the claims are therefore intended to be embraced.

The invention claimed is:

1. A computer-implemented method for dynamically matching a request from a
requestor with a member population, comprising:
receiving, from a server, a request from the requestor wherein the request includes at least one population profile identifier, a sample size and a predetermined time period for response;
generating, by the processor, an initial member population including one or more candidates, each of whom is relevant to the at least one population profile identifier;
generating, by the processor, a final member population including a subset of the initial member population based on a candidate preference and a candidate profile standing;
sending, by the server, a first request to a first subset of the final member population;
determining whether a number of respondents to the first request in an elapsed time period is more than or equal to the sample size;
sending, by the server, a subsequent request to a subsequent subset of the final member population if the number of respondents to the first request is less than the sample size and if the elapsed time period is less than the predetermined time period for response;
determining whether a total number of respondents to the first request and the subsequent request in the elapsed time period is more than or equal to the sample size,
sending the subsequent request to the subsequent subset of the final member population if the total number of respondents to the first request and the subsequent request is less than the sample size and if the elapsed time period is less than the predetermined time period for response; and
transmitting, by the server, to the requestor a visual representation comprising the response obtained by the total number of respondents when the total number of respondents is equal or more than the sample size and the elapsed time period exceeds the predetermined time period for response.

2. The computer-implemented method according to claim I wherein the first subset of the final member population is generated by determining an oversampling number, wherein the oversampling number includes an aggregate of the sample size and a predetermined percentage of the sample size.

3. The computer-implemented method according to claim I wherein each of the one or more candidates is selected based on its association with the at least one population profile identifier.

4. The computer-implemented method according to claim I wherein the candidate preference includes a time availability for response to the first request.

5. The computer-implemented method according to claim I wherein the candidate profile standing is indicative of seniority, stature or standing of each of the one or more candidates within the user population.

6. The computer-implemented method according to claim I wherein the elapsed time period is indicative of the time passed since the first request was sent.

7. The computer-implemented method according to claim I wherein the visual representation includes one or more of the following: statistics, graphics, charts, and table.

8. The computer-implemented method according to claim 1, wherein the at least one population profile identifier includes one or more of the following:
age group, gender, birth date, current geolocation, religion, nationality and country of residence.

9. The computer implemented method according to claim 1, wherein the initial member population includes the one or more candidates located within a selected geolocation.

10. The computer implemented method according to claim 1, wherein the first request sent to the first subset of the final member population is sent at a predetermined time interval.

11. The computer-implemented method according to claim 1, further comprising:
generating, for the initial member population, a relevance score reflecting a relevance to the at least one population profile identifier.

12. The computer-implemented method according to claim 11, wherein the relevance score is computed based on the association of each candidate to the at least one population profile identifier.

13. A system for dynamically matching a request from a requestor with a member population, the system comprising:
at least one processor; and
at least one memory including computer program code;
the at least one memory and the computer program code configured to, with the at least one processor, cause the system at least to:
receive, from a server, a request from the requestor wherein the request includes at least one population profile identifier, a sample size and a predetermined time period for response;
generate, by the processor, an initial member population including one or more candidates, each of whom is relevant to the at least one population profile identifier;
generate, by the processor, a final member population including a subset of the initial user population based on a candidate preference and a candidate profile standing;
send, by the server, a first request to a first subset of the final member population;
determine whether a number of respondents to the first request in an elapsed time period is more than or equal to the sample size;
send, by the server, a subsequent request to a subsequent subset of the final member population if the number of respondents to the first request is less than the sample size and if the elapsed time period is less than the predetermined time period for response;
determine whether a total number of respondents to the first request and the subsequent request in the elapsed time period is more than or equal to the sample size,
send the subsequent request to the subsequent subset of the final member population if the total number of respondents to the first request and the subsequent request is less than the sample size and if the elapsed time period is less than the predetermined time period for response; and
transmit, by the server, to the requestor a visual representation comprising the response obtained by the total number of respondents when the total number of respondents is equal or more than the sample size and the elapsed time period exceeds the predetermined time period for response.

14. The system according to claim 13, wherein the first subset of the final member population is generated by determining an oversampling number, wherein the oversampling number includes an aggregate of the sample size and a predetermined percentage of the sample size.

15. The system according to claim 13, wherein each of the one or more candidates is selected based on its association with the at least one population profile identifier.

16. The system according to claim 13, wherein the candidate preference includes a time availability for response to the first request.

17. The system according to claim 13, wherein the candidate profile standing is indicative of seniority, stature or standing of each of the one or more candidates within the user population.

18. The system according to claim 13 wherein the elapsed time period is indicative of the time passed since the first request was sent.

19. The system according to claim 13 wherein the visual representation includes one or more of the following: statistics, graphics, charts, and table.

20. The system according to claim 13 wherein the at least one population profile identifier includes one or more of the following: age group, gender, birth date, current geolocation, religion, nationality and country of residence.

21. The system according to claim 13, wherein the initial member population includes the one or more candidates located within a selected geolocation.

22. The system according to claim 13, wherein the first request sent to the first subset of the final member population is sent at a predetermined time interval.

23. The system according to claim 13 further comprising: generating, for the initial member population, a relevance score reflecting a relevance to the at least one population profile identifier.

24. The system according to claim 23, wherein the relevance score is computed based on the association of each candidate to the at least one population profile identifier.

25. (canceled)

26. (canceled)
